(19) United States
(12) Patent Application Publication
(10) Pub. No.: US 2002/0129342 A1
(43) Pub. Date: Sep. 12, 2002

(54) Data mining apparatus and method with user interface based ground-truth tool and user algorithms

(76) Inventors: David Kil, Gilroy, CA (US); Andrew Bradley, Huntington Beach, CA (US)

Correspondence Address: WELSH & KATZ, LTD, 120 S RIVERSIDE PLAZA, 22ND FLOOR, CHICAGO, IL, 60606, US

(21) Appl. No.: 10/087,311

(22) Filed: Mar. 1, 2002

Related U.S. Application Data
(60) Provisional application No. 60/274,008, filed on Mar. 7, 2001.

(51) Int. Cl. G06F 9/45

(52) U.S. Cl. 717/137

(57) ABSTRACT

Various modes and embodiment of a method, apparatus, user interface, article of manufacture including a computer readable medium, computer data signals embodied on a carrier wave, and computer system for a GUI-based ground truth tool and insertion of user algorithms written in multiple programming languages. One embodiment comprises user interface for inserting a custom algorithm in a data-mining application. Another embodiment comprises a ground truth tool in a data-mining-application. A third embodiment comprises seamless insertion of custom algorithms in a data-mining application using tap points.

### PRIORITY CLAIM

This application claims the benefit of U.S. Provisional Application Ser. No. 60/274,008, filed Mar. 7, 2001, which is herewith incorporated herein by reference. This application is related to U.S. application Ser. No. 09/945,530, entitled “Automatic Mapping from Data to Preprocessing Algorithms” filed Aug. 30, 2001 (attorney docket number 7648/81349 00SC105,111), which is herewith incorporated herein by this reference. This application is also related to U.S. application Ser. No. 09/942,435, entitled “Data Mining Application with Improved Data Mining Algorithm Selection” filed Nov. 16, 2001 (attorney docket number 7648/81348 00SC1069), which is herewith incorporated herein by this reference. This application is also related to international application serial number Not Yet Assigned, entitled “Method and Apparatus for One-Step Data Mining with Natural Language Specification and Results” filed the same day as this application, which is incorporated herein by reference. This application is also related to international application serial number Not Yet Assigned, entitled “Hierarchical Characterization of Fields from Multiple Tables with One-to-Many Relations for Comprehensive Data Mining,” filed the same day as this application, which is incorporated herein by reference.

### TECHNICAL FIELD

This invention relates generally to knowledge discovery in data and data mining software applications. More specifically this invention relates to an apparatus and method for data mining having a user interface, such as a graphical user interface (GUI), based tool for generating ground truths and for file based tap points for incorporating user-defined algorithms.

### BACKGROUND ART

In most data-mining applications using existing technology, it is assumed that a target variable is always available. In some time-series and image data analysis applications and databases involving multiple hierarchical tables, however, the target variable is not always available as one of the observed variates in the data set. Moreover, the target variable sometimes cannot be expressed as a simple mathematical function of the existing variables. Instead, in such situations some additional processing must be performed on a combination of the variables in order to derive the target variable. After the target value is so derived, data mining techniques can be employed to identify relationships between that computed value and the other data measurements.

Sometimes, the output cannot be expressed with a mathematical combination of existing fields. As one example, efforts to identify actionable information in a series of mammogram images can pose such a problem. There is a need for a data-mining algorithm to detect and classify data such as mammogram calcifications and fuzzy spread patterns. The objective in this example would be to develop a data mining technique that can identify regions likely to be of interest to a human expert in that field. Another example is cell analysis in tissue preparation prior to gene-chip image analysis. Here the goal is to extract the precise cells affected by diseases for accurate gene analysis for diagnostic and prognostic applications. For such applications, it would be preferable to have a GUI-based annotation tool that allows a domain expert to identify and annotate various regions of interest in mammogram images. Such a tool would be simpler and more accurate than available alternatives.

More than looping and logic capabilities are required to produce this result. While it is desired in this example to develop a program that can identify regions of interest in mammogram images, in order to apply data mining techniques it is necessary to have examples of such regions already identified. The problem poses a “chicken-and-egg” issue. A problem to be solved in this example is to design a sophisticated data-mining algorithm to learn interesting patterns and identify them the next time it sees them. If an elegantly simple mathematical formula could be derived, a complex data mining system would be unnecessary. However, if an intuitive and simple way could be found to identify these interesting patterns to the algorithm, then the possibility of learning from these patterns would be greatly enhanced. The identity of these patterns of interest is the “ground truth.” The data-mining algorithm will try to find the relationship between these patterns and their identities. As is well known, failure to identify accurately the goal of the data mining operation can significantly impair the results of the operation, which can be seen as an instance of the maxim “garbage in, garbage out.”

As a further example, a business executive may desire to predict sudden changes in demand conditions that will impact the executive's business in the future. A home purchaser may want to study the relationship between home-price trends and a number of macroeconomic, demographic, and regional factors.

While it is known in the art to use an annotation tool for a certain highly specific application area such as a genomic database, such annotation tools in current practice tend to be highly specialized and inflexible in that they are incapable of incorporating user algorithms. There is therefore a need to provide a generalized ground-truth tool with supporting algorithms and capabilities to insert the user's algorithms that can be applied to a wide variety of applications.

When the output desired to be predicted is not contained directly in the database fields and cannot be expressed easily as a mathematical combination, there is a need to provide a tool such as a GUI-based tool that would permit the user to specify which fields would be used to generate the output and to annotate target outcomes if they cannot be easily expressed in logic. There is also a need for the ability to create a new database field.

A ground-truth tool assigns a category or grade, rating, or evaluation (which can be a continuous number) to an object so that a data-mining algorithm can be designed around the data with ground truth. Examples of objects to which categories can be assigned include image, time-series segments, video, and others. In some data mining problems no single field represents an output variable. In such problems, there is no single field containing a ground truth label.

Sometimes the dependent variable can be expressed as a mathematical function of a fixed number of fields. Sometimes, however, it is not possible to express the dependent variable as a mathematical function of a fixed number of fields. When it is not possible to express the dependent variable as a mathematical function of a fixed number of fields, the dependent variable must be derived from a combination of temporally and/or spatially sampled fields. As one example, in some application problems it can be necessary to derive the dependent variable from fields such as profit trends. In other application problems, it can be necessary to derive the dependent variable from fields such as demand forecasting. In other application problems it can be necessary to derive the dependent variables from other quantities, or from some combination of quantities. There is a need, therefore, for an easy-to-use GUI tool that facilitates generation of the dependent variable from the sampled data.

Many operations for knowledge discovery in data can require specialized algorithms. As one example, domain-specific signal processing, which concerns the analysis of time-series information, can require specialized algorithms. Similarly, domain-specific image processing, which concerns the analysis of two- and three-dimensional image or video data, can require specialized algorithms. Other data-mining applications, as well, can require specialized algorithms.

Many current data-mining tools do not take into account the observation that many operations for knowledge discovery in data can require specialized algorithms. Ignoring this fact can yield sub-optimal processing strings. In addition, to ensure that an algorithm is robust to real processing conditions, the design and development of algorithms must occur within the context of related algorithms and real-world data. There is a need, therefore, for a data-mining enhancement that allows experts to design and implement their own situation-specific processing algorithms, and insert them into the data-mining tool in a seamless manner using a GUI. This need is for a GUI-based ground-truth tool to assist the user to create a new target field so that the data-mining application can be designed using existing user data and the new target field.

During a typical sequence of signal-processing or data mining steps, it may be desirable to gain access to intermediate analysis results for further processing by the user. There is a need, therefore, for a data mining application that provides various file-based tap points, so each user is allowed to perform on the tap outputs whatever algorithmic operations using whatever tools he is comfortable with.

In this application, the use of the disjunctive is intended to include the conjunctive. The use of definite or indefinite articles is not intended to indicate cardinality. In particular, a reference to “the” object or “a” object is intended to denote also one of a possible plurality of such objects.

### DISCLOSURE OF INVENTION

The invention, together with the advantages thereof, may be understood by reference to the following description in conjunction with the accompanying figures, which illustrate some embodiments of the invention.

One mode of practicing one embodiment is a graphical user interface for inserting a custom algorithm in a data-mining application. The graphical user interface includes a control to upload an algorithm source code and a control to query the user for input and output parameter information. The graphical user interface in this mode of practicing this embodiment is available to pass the algorithm source code to an evaluation process, and the evaluation process is available to determine whether the user has properly implemented interface requirements. The graphical user interface in this mode of practicing this embodiment is available to pass the algorithm source code to a wrapping process that wraps the algorithm in an appropriate language-specific accessor function. The algorithm source code can be written in a high level-language, such as C, C++, Java, Matlab, Fortran, Pascal, and Visual Basic. The control to upload an algorithm source code can be a single control element or a plurality of elements including: a text box in which to identify a file, a browse button with which to select a file, and an upload button with which to initiate the upload process. The input and output parameter information can include data format, default values, help dialogs, and parameter relationships. The interface requirements checked by the evaluation process can include an entry point into the code and exit state. The wrapping process can be a back-end procedure.

Another mode of practicing this embodiment is a method for inserting a custom algorithm in a data-mining application. The method of this mode of practicing this embodiment includes uploading an algorithm source code, receiving input and output parameter information from the user, evaluating the algorithm source code to determine whether the user has properly implemented interface requirements; and passing the algorithm source code to a wrapping process that wraps the algorithm in an appropriate language-specific accessor function. The algorithm source code can be written in a high level-language, such as C, C++, Java, Matlab, Fortran, Pascal, and Visual Basic. The input and output parameter information can include data format, default values, help dialogs, and parameter relationships. The interface requirements evaluated can include an entry point into the code and exit state.

Another mode of practicing this embodiment is an article of manufacture for inserting a customer algorithm into an analysis environment. The article of manufacture includes a computer readable media containing computer program code segments. A computer program code segment uploads an algorithm source code. A computer program code segment receives input and output parameter information from the user. A computer program code segment evaluates the algorithm source code to determine whether the user has properly implemented interface requirements. A computer program code segment also passes the algorithm source code to a wrapping process that wraps the algorithm in an appropriate language-specific accessor function. Another mode of practicing this embodiment is a computer data signal embodied in a carrier wave encoding a computer program for inserting a custom algorithm in a data-mining application. The computer program includes instructions for performing the method summarized above.

Another mode of practicing this embodiment is a data-mining computer system adapted for inserting a custom algorithm into the data mining application. The system includes an upload control that uploads an algorithm source code. It also includes a parameter control that receives input and output parameter information from the user. There is also an evaluation process that evaluates the algorithm source code to determine whether the user has properly implemented interface requirements. The system also includes a wrapping process that wraps the algorithm in an appropriate language-specific accessor function. Another mode is a client system adapted for inserting a custom algorithm into a data-mining application. Yet another mode is a server system wherein a custom algorithm can be inserted into an analysis environment.

A mode of practicing a second embodiment is a method of providing a ground truth tool in a database having data fields. The method includes processing to detect, to cluster, and to track contiguous events, presenting detected, clustered, and tracked contiguous events in groups wherein the members of each group have similar characteristics, and receiving input assigning class labels to the events. The processing can be digital signal processing to detect, to cluster, and to track temporally contiguous events, or image processing to detect, to cluster, and to track spatially contiguous events, or a combination of the two. The method can also include storing the class labels in a new data field appended to the database. Events can be presented and input received with controls of a graphical user interface.

Another mode of practicing this embodiment is a computer program storage medium readable by a computing system and encoding a computer program for providing a ground truth tool, which performs the summarized method. Another mode is a computer data signal embodied in a carrier wave by a computing system and encoding a computer program for providing a ground truth tool, which performs the summarized method. Another mode of practicing this second embodiment is a computer system having a data-mining application and including a ground truth tool, including means for performing the steps of the summarized method.

A mode of practicing a third embodiment is a method for seamless insertion of custom algorithms in a data-mining application using tap points. The method includes using a computer system for machine-assisted problem exploration in a data-mining application. The computer system includes a problem-definition user interface. The method also includes concluding at some point that additional operations are needed that are too complicated to be specified easily using the problem-definition interface. The method includes displaying to the user all data-mining steps and a tap-point dissemination helper; and receiving input from the user specifying when to extract an intermediate output for further processing. The tap points are file-based or through other means of inter-process communication, such as shared memory, semaphore, and others. The machines-assisted problem definition can use, for example, a Bayesian network or a decision tree. The displaying step and the receiving input step can use a graphical user interface. User input can also specify the format in which data will output.

Another mode of practicing this third embodiment is a user interface adapted for specifying data tap-points in a data-mining application. The interface includes (1) an output that displays information about the data-mining steps and a tap-point dissemination helper and (2) an input that receives information from the user to specify when to extract an intermediate output for further processing. The output and the input can be controls on a graphical user interface. Intermediate output can be extracted at file-based tap points identified by the user.

Another mode of practicing this third embodiment is a computer readable medium comprising instructions for seamless insertion of custom algorithms in a data-mining application using tap points. The instructions when executed in a processor perform the steps summarized above in the method of this embodiment. Another mode of practicing this third embodiment is a computer data signal embodied in a carrier wave and representing sequences of instructions which, when executed by a processor, cause said processor to seamlessly insert a custom algorithms in a data-mining application using tap points by performing the steps of the method of this embodiment. Another mode of practicing this third embodiment is a computer system including means for insertion of custom algorithms in a data-mining application using tap points, which includes means for performing the steps of the method of this embodiment.

Another mode of practicing this third embodiment is a computer system including seamless insertion of custom algorithms in a data-mining application using tap points. The computer system includes a memory and a central processor and a machine-assisted problem exploration processor in a data-mining application. It also includes an output device (such as a display or printer) that communicates data-mining steps and communicates a tap-point dissemination helper when additional operations are needed that are too complicated to be specified easily using the machine-assisted problem exploration processor. It also includes an input device (such as a keyboard) for receiving input from the user specifying when to extract an intermediate output for further processing.

### BRIEF DESCRIPTION OF DRAWINGS

Several aspects of the present invention are further described in connection with the accompanying drawings in which:

FIG. 1 is a data flowchart that illustrates an example of a path of data in solving the problem using a GUI based ground truth tool and user-defined algorithms in data mining.

FIG. 2 is a program flowchart illustrating an example of a sequence of operations and control flow in using a GUI based ground truth tool and user-defined algorithms in data mining.

FIG. 3A, FIG. 3B, FIG. 3C, FIG. 3D, and FIG. 3E illustrate a series of screen shots illustrating one embodiment of a ground truth tool.

FIG. 4 is an example depicting phase map transformation of raw time-series data.

FIG. 5 is an example depicting synthetic aperture processing of image spatial data.

FIG. 6 is an example depicting voice stress classification and speaker identification.

FIG. 7 illustrates a program flowchart for a sequence of operations and the passing of control in an embodiment of a tool for inserting a custom algorithm in a data-mining application.

FIG. 8 illustrates a program flowchart for a sequence of operations and the passing of control in an embodiment of GUI-based ground truth tool for situations in which there is no obvious target variable.

FIG. 9 a program flowchart for a sequence of operations and the passing of control in an embodiment for providing file-based tap points for seamless insertion of user algorithms for customization of a data-mining application.

FIG. 10 is a block diagram that generally depicts a configuration of one embodiment of hardware suitable for a GUI based ground truth tool and user-defined algorithms in data mining.

### MODES AND BEST MODE FOR CARRYING OUT THE INVENTION

While the present invention is susceptible of embodiment in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

If none of the database fields match the user's goal specification, then the actual target field must be calculated from the existing fields. This situation can arise frequently in, for example, financial and econometric data analysis. As another example this situation can also arise in image analysis.

One embodiment is a method to generate a target/output variable in data mining when the target field does not exist in database fields and cannot be derived from a mathematical or logical combination of the database fields. This embodiment derives the target variable from one or more fields after going through a set of signal processing and/or user-defined processing algorithms. An embodiment also includes a GUI-based ground-truth tool and a library of algorithms that can be applied to a wide variety of applications. The tool in this embodiment can be flexible enough to allow a user to insert the user's own algorithms, written in any of various programming languages, with file-based tap points for easy input-output (I/O) interface.

A GUI-based ground-truth tool in one embodiment helps the user create a new target field so that a data-mining algorithm can be designed using the existing database and the new target field. During a typical sequence of ground-truth determination steps, it is often desirable to gain access to intermediate analysis results for further processing by the user. This embodiment can provide various file-based interface points, such that at each one the user is allowed to perform on the tap outputs whatever algorithmic operations using whatever tools the user selects.

In one embodiment, a GUI guides the user to upload an algorithm written in one of several commonly used computer languages. Examples of such computer languages that can be used include, but are not limited to, C, C++, Java, Matlab, and Fortran. The algorithm can be uploaded in the form of text source file. In an alternative, the algorithm can be uploaded in the form of object code for a particular machine.

The GUI in this embodiment also queries the user for I/O parameter information. I/O parameters information can include, for example, data format, default values, help dialogues, and parameter relationships, as well as access permissions for the algorithm. The input information regarding I/O parameters, in conjunction with the definition of the actual algorithm, provides in this embodiment all the information needed for the interface to evaluate the proposed new algorithm.

The GUI in this embodiment examines the algorithm text to ensure that the user has properly implemented any necessary interface requirements. One example of such an interface requirement can be an entry point into the code. A second example of such an interface requirement can be an exit state. Ensuring compliance with interface requirements can help avoid run-time errors in implementing the algorithm.

The GUI in this embodiment calls a backend procedure to wrap the algorithm in an appropriate language-specific accessor function. This accessor function can, in one embodiment, be in the form of a run-time interpreter. In a second embodiment the accessor function can transform the algorithm from the input high-level language to a meta language uniform within the data-mining application but machine independent. In a third embodiment, instead of an accessor function as such the data mining application can pass the algorithm definition to an available compiler to produce object code for integration in the data mining application.

Once the algorithm is integrated into the analysis environment, the user can then employ it like any other algorithm. Moreover, the algorithm can be published at any level of public access. Thus, the GUI of this embodiment allows the user to tailor the data-mining product to the user's specific requirements at a fundamental level of analysis and allows other users to access these modifications as they do the built-in algorithms.

In one embodiment, the GUI has built-in digital signal processing (“DSP”) and image-processing (“IP”) functions that detect, cluster, and track spatially and/or temporally contiguous events. These clustered and tracked events can be presented in groups of similar characteristics so that a data expert can easily and accurately assign the same class label to them. That class label can then be a value for a dependent variable.

As one example of an embodiment with built-in DSP and IP functionality, the GUI of one such embodiment graphically presents a group of moving storm cells with changing spatial and intensity characteristics over time. This information can help a meteorologist to declare quickly and accurately the severity of the storm system. A meteorologist using this embodiment can observe how the same storm cell evolves over time. Instead of single-frame ground truth determination, multiple frames of image data can be processed simultaneously for more accurate storm annotation. The newly created dependent variable can be stored in a new field and appended to the image feature database.

Another embodiment allows the user to define and access file based tap points for the seamless insertion of a user's own algorithms for customizations. In this embodiment, data exploration can be guided by means such as a decision tree or a Bayesian network. During the decision tree-guided and/or Bayesian network-guided data exploration, there can come a point at which the algorithm, the user, or both determine that any additional operations that must be done to data prior to the commencement of data mining are too complex to be easily specified in the environment of a graphical user interface using a control such as a textbox environment. The user in this embodiment can order that the data be written to a file that can be read by the user's analysis tool of choice. Examples of appropriate analysis tools can include, but are not limited to, Matlab, Excel, Visual Basic, C++, ILOG, S+, and others.

This embodiment includes a GUI tool that displays all the steps in data mining and a tap-point dissemination helper. The tap-point dissemination helper allows the user to specify where to extract an intermediate output in his preferred data format for further processing. This capability allows the data-mining application with the GUI of this embodiment to offer flexibility, while preventing it from becoming bloated by trying to be all things to all users.

An embodiment of the invention includes of a GUI that displays all the steps in data analysis and a tap-point dissemination helper, which allows the user to specify where to extract an intermediate output in his preferred data format for further processing. This file-based interface capability allows the user to substitute his processing in place of built-in functions for flexibility. In another embodiment, tap points need not be file based. The relevant information can be stored in a database. The one advantage with the file-based system is that the user can check intermediate results without having to go through database.

In this embodiment, if the user is not satisfied with the built-in functions, the tool also provides a flexible interface facility through which the user can access intermediate processing results in any specified file format. Examples of such file formats can include Excel, Matlab, and others. The user of this embodiment can process this data file in anyway and in any programming language with which the user is familiar. The output of the user's analysis can be fed back to the data-mining environment so that a DM operation can commence with the newly created target variable and refined intermediate processing results. Thus, the user can define the user's own target variable and process intermediate processing results in any way using the user's own custom algorithms. The tap points are available so that the user can process intermediate results and reinsert the refined results back to the data-mining operation for improved performance.

These embodiments can allow the user to generate the user's own target variable using built-in functions or own algorithms wrapped in a master GUI. Built-in grouping and tracking algorithms can allow ground-truth determination across time and spatial dimensions. Special-event detection can also be provided so that normal events can be discarded. Provision can also be made in an embodiment to allow the insertion a user's own algorithms through file-based tap points. Such an embodiment facilitates sophisticated data mining when no target variables are readily available.

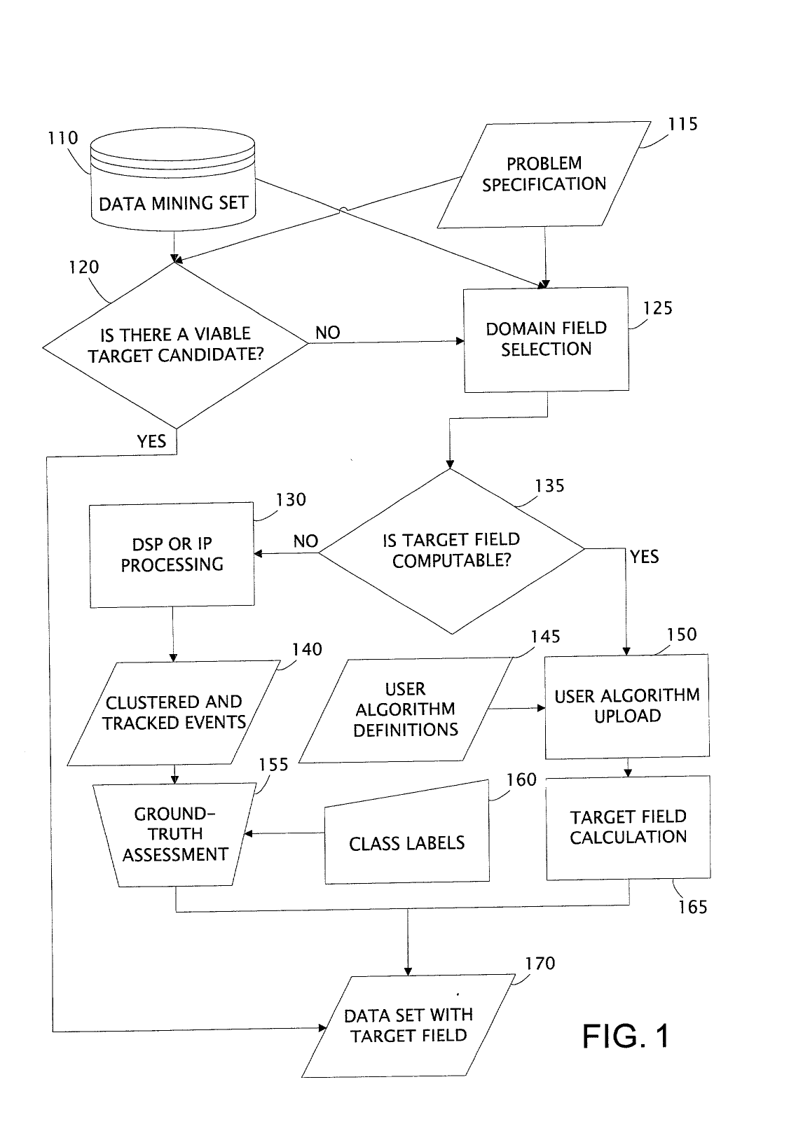

Referring now to FIG. 1, there is disclosed a data flowchart that illustrates a path of data using a GUI based ground truth tool and user-defined algorithms in data mining. A data mining database (110) is provided, containing observations, measurements, and/or the like. Typically a user will desire to extract useful information about correlations and relationships among and between data in the data mining database (110). The data mining database (110) can contain any type of information. Possible examples include time series data such as stock market prices or image data such as radar or sonar scans.

There is also provided problem specification data (115), which data defines the goal of the data-mining problem. Problem specification data (115) can be entered, for example, as a formula defining source and target fields. The data mining database (110) and problem specification data (115) are analyzed and control passes based on a viable-target-field-candidate evaluation (120). If, in the affirmative, there exists a viable target field candidate, then that candidate is selected as the target field and the data set with target field data (170) is provided to the data mining application software.

If no viable target field candidate is identified, then a domain-field-selection process (125) is activated. The domain-field=selection process (125) uses both the data-mining database (110) and the problem specification data (115). The domain field selection process (125) produces a domain field set. Control then branches based on a target-field-computability evaluation (135). The target-field-computability evaluation (125) can be based on a query to the user or can be performed automatically using built-in macros, for example. If, in the affirmative, the target field is computable then control passes to a user-algorithm-upload process (150). The user-algorithm-upload process (150) incorporates user algorithm definition data (145). User algorithm definitions data (145) can contain an algorithm written in any one of various known languages, including (but not limited to) C, C++, Java, Matlab, or Fortran. Control then passes to a target-field-calculation process (165), which uses the user algorithm definitions data (145) incorporated by the user-algorithm-upload process (150) to computer the target field, and the data set with target field data (170) is provided to the data mining application software.

If the target field is not computable then control passes to a DSP-or-IP-processing process (130). The DSP-or-IP-processing process (130) applies known digital signal processing or image processing pre-conditioning algorithms to the data mining database (110) data. Such preconditioning algorithms help to eliminate anomalies in the data and facilitate the visual inspection of data for assessment of ground truth conditions. Such digital signal processing or image processing pre-conditioning algorithms also help to cluster data and provide tracking, which also facilitates the visual inspection of data for assessment of ground truth conditions. The DSP-or-IP-processing process (130) generates clustered and tracked event data (140). Clustered and tracked event data (140) is passed to a ground-truth-assessment process (155). The ground-truth-assessment process (155) is a user input process by which data set classifications (ground truths) are established. Typically, DSP and IP algorithms sort input data based on time, space, and frequency, generating data clusters. Additional features can be extracted from each cluster that represent the characteristics of each cluster. The user then provides class labels (160) to each cluster in an annotation process. The class labels (160) are appended to the features derived from each data cluster, forming a vector or token. All the tokens from the entire data set are merged into a matrix. This provides the target field for data mining. After the ground truth-assessment process (155) has completed, the data set with target field data (170) is provided to the data mining application software.

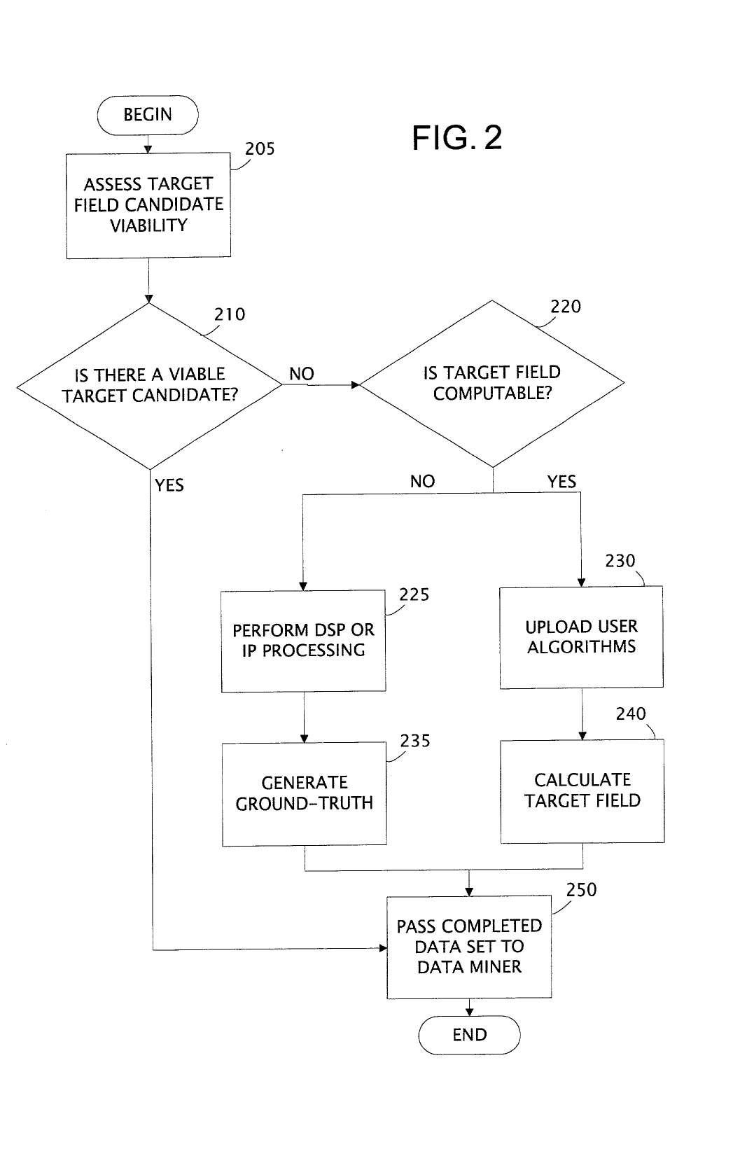

Referring now to FIG. 2, there is disclosed a program flowchart illustrating a sequence of operations and control flow in using a GUI based ground truth tool and user-defined algorithms in data mining. When the program is first activated control goes first to an assess-target-field candidate-viability process (205). The assess-target-field-candidate-viability process (205) examines the data included in the database and the description of the data mining problem to determine if the target field exists in the data mining database. Control next branches based on a viable-target-candidate-field evaluation (210). If in the affirmative there is a viable choice for the target candidate field then the process is complete and control goes to a pass-completed-data-set-to-data-miner process (250). The viable-target-candidate-field evaluation (210) can be based on the program's computational or heuristic evaluation of data or can be based in whole or in part on user input.

If the result of the target-candidate-field evaluation (210) is that there exists no viable target candidate in the database given the problem definition, then control passes next to a target-field-computability evaluation (220). Like the target-candidate-field evaluation (215), this evaluation can be based on mathematical or heuristic computations, or can be driven responsive to user input. The target field is computable if it can be calculated as a function of some other fields in the database.

If the target-field-computability evaluation (220) indicates in the affirmative, that the target is computable, then control passes to an upload-user-algorithm process (230) as the first step on a branch to deal with computable target fields. The upload-user-algorithms process (220) receives input from the user specifying the user's algorithm. This input can be in the form of source code in some high level language specifying the processing algorithm, as well as additional information concerning parameters and the like. The upload-user-algorithms process (220) passes control to a calculate-target-field process (240). The calculate-target-field process (240) uses the algorithm specified by the user in the upload-user-algorithm process (220) to compute a value that will serve as the target of the data mining operation. The goal of data mining is to find a mathematical relationship between inputs and output or target. If a target field can be easily expressed as a function of input fields, then there may be no need for data mining. Therefore, the fields used to derive the target variable can be excluded from inputs, because those fields represent trivial knowledge. For example, if customer value is defined as total sales divided by membership period, those two variables can be removed from the input list when the problem is submitted to a data mining application. Having removed those fields from the list of inputs, data mining must find what other input fields can be used to identify high—value customers—i.e., non-trivial and insightful knowledge. The calculate-target-field process (240) passes control to the pass-completed-data-set-to-data-miner process (250).

If, to the contrary, the target-field-computability evaluation (220) indicates in the negative, that the target is not computable, then control passes to a perform-DSP-or-IP processing process (225) as the first step on a program branch to deal with data and problem definitions for which a suitable target field cannot be defined as a function of the database table fields. The perform-DSP-or-IP-processing process (225) uses known image processing techniques to analyze spatial data or known digital signal processing techniques to analyze time-series data, or some combination of both. It clusters and groups the data, then passes control to a generate-ground-truth process (235). The generate-ground-truth process (235) displays the clustered and grouped data and receives input labeling events. The input event labels can then used as the target field for the data mining operation, and control passes next to the pass-completed—data-set-to-data-miner process (250).

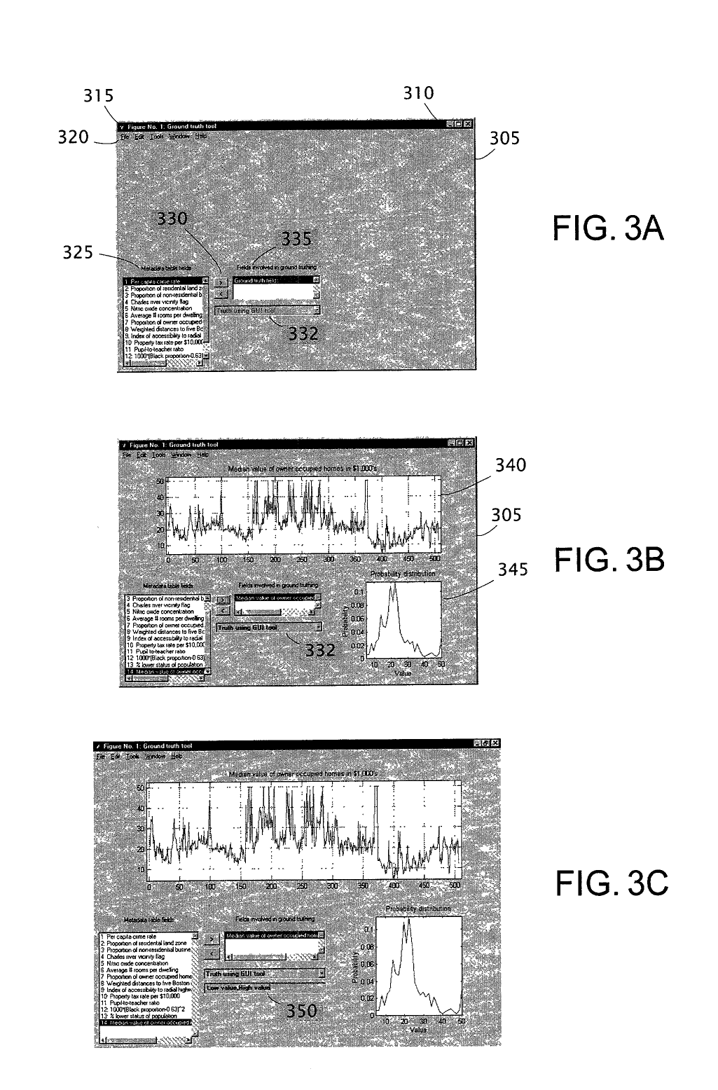

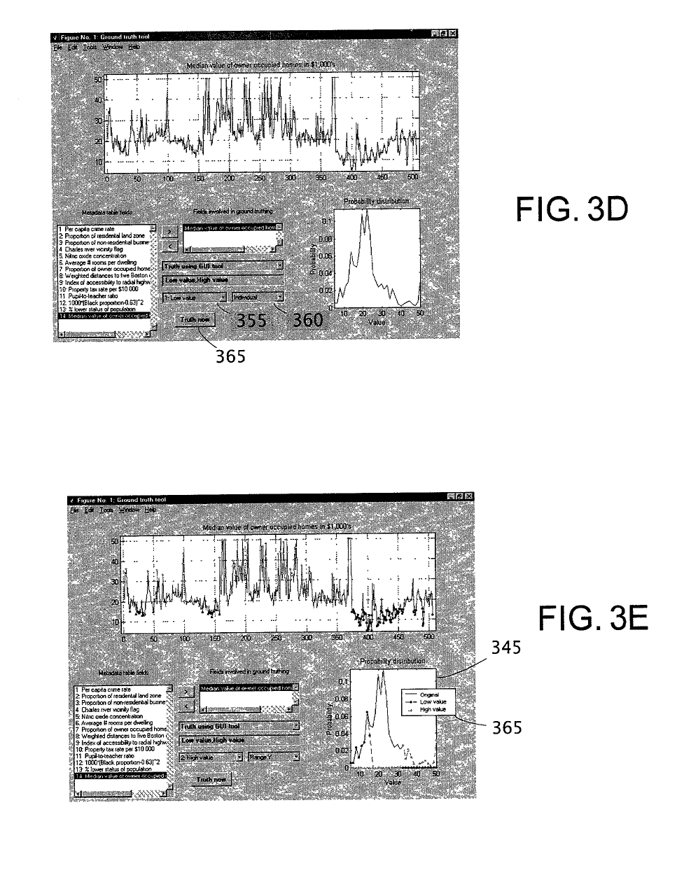

Referring now to FIG. 3A, FIG. 3B, FIG. 3C, FIG. 3D, and FIG. 3E, there are depicted a series of screen shots illustrating one embodiment of a ground truth tool. As depicted in FIG. 3A, a dialog window (305) is displayed, having conventional elements such as control buttons (310), a title bar (315), and a task menu (320). The control buttons (310) can offer such options as minimizing the window, maximizing the window, restoring the window, and closing the window. The title bar (315) can display a title such as “Figure No. 1. Ground Truth Tool”. The task menu (325) can contain typical menu selections such as file, edit, tools, window, and help, which in turn can offer options such as, for example, load information, save information, new information, cut, paste, copy, switch window, layout windows, resize windows, move windows, user assistance information, and program identification information.

Referring still to FIG. 3A, a table fields list box (325) in this embodiment lists all the fields from a table on which a data-mining operation will be performed. The table fields list box (325) can include conventional elements such as slider controls and a caption display. A ground truth fields list box (335) in this embodiment lists those fields that the user identifies as being involved in the determination of ground truth. Command buttons (330) in this embodiment can be used to add fields from the table fields list box (325) to the ground truth fields list box (335). In one embodiment the table fields list box (325) need only list those fields not already selected as being involved in the ground truth determination. Command buttons (330) can also remove fields from the ground truth fields list box (335), restoring them to the table fields list box (325).

In the depicted embodiment, a ground truth tool selector control (332) is used to identify what ground truth tool to use. A user can select to use, for example, a graphical user interface or some other program to determine ground truth. In FIG. 3A, the ground truth tool selector control (332) is grayed out as inactive because no fields have yet been selected and added to the list displayed in the ground truth fields list box (335). In FIG. 3B, the ground truth tool selector control (330) is now active because at least one field has been selected for inclusion in the ground truth fields list box (335). After the user selects fields to be used in generation of a new target field using the table fields list box (325), command buttons (330), and the ground truth fields list box (335), the dialog window (305) can also provide other information such as a graph display (340) of values and/or a probability distribution display (345) showing a histogram of the probability distribution of values.

As shown in FIG. 3C, s descriptive label control (350) in this embodiment provides a means for the user to enter descriptive labels for class labels. The descriptive label control (350) can be in the form of, for example, a text box. As shown in FIG. 3D, annotation controls (355, 360) are provided in this embodiment, with which the user can select class labels and start annotating using a variety of options. A truth now command button (365) is provided in this embodiment for the user to select after the user has finished annotation. Selecting the truth now command button (365) will cause the class labels added by the annotation process to be included in the data table being annotated so that they are available as the target of a data mining operation. In FIG. 3E, after the truth now command button (365) has been selected and the associated process executed, the probability distribution display (345) is updated to include a class information display (365). In the depicted example, a data field has be divided into two classes by annotation, which two classes fall at either extreme of the probability distribution.

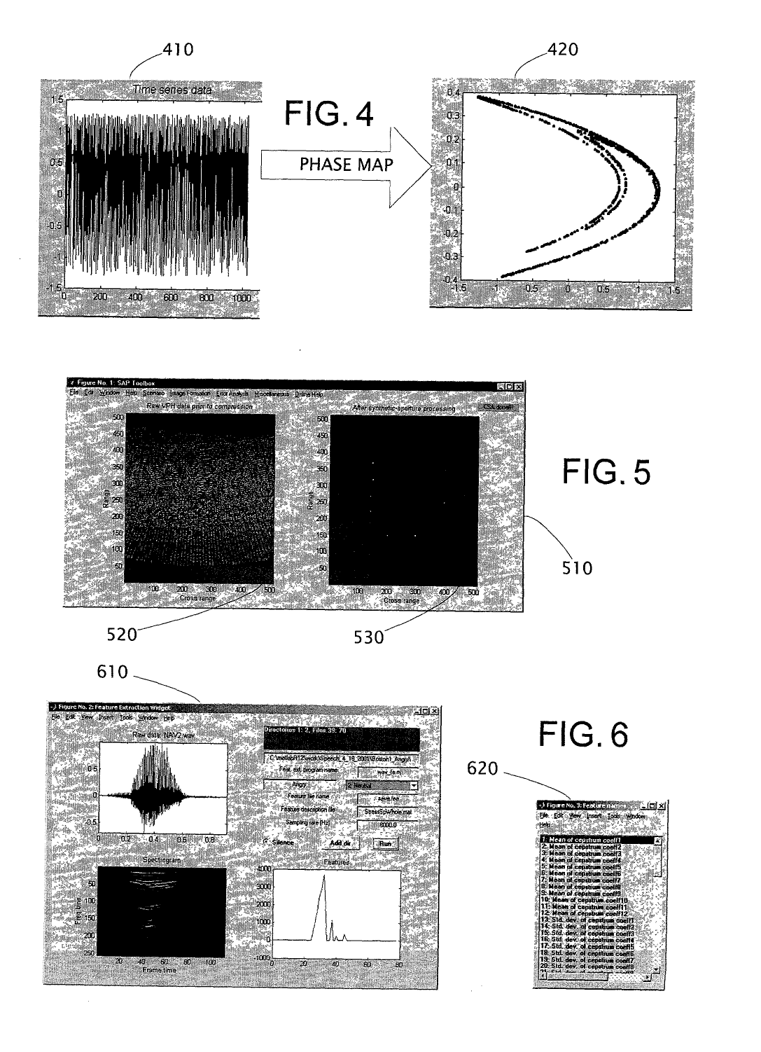

Referring now to FIG. 4, FIG. 5, and FIG. 6 there are depicted three particular examples of computable target fields for which the data is transformed automatically. Many possible examples of such transformation are known, and the area includes ongoing topics of current research and development. Particular examples include time-frequency representation; constant false alarm rate, detection, and clustering; transform basis functions; and chaos signal processing. It is considered within the scope of this invention to incorporate any such automatic transformations now known or later developed into the embodiments described hereinabove.

Referring first to FIG. 4, a time series data display (410) depicts raw time series data. Such raw time series data may be transformed by, for example, a phase-map transformation. A phase map display (420) depicts the results of this transformation.

Referring now to FIG. 5, a synthetic aperture processing dialog box (510) is shown. The synthetic aperture processing dialog box (510) includes a raw data display (520) and a processed data display (530). The raw data display (520) can suggest a diffraction pattern, which can indicate that synthetic aperture processing may be appropriate. Synthetic aperture processing can include particular functions known in the art, such as chirp scaling, range migration, polar formatting, and back-projection. The processed data display (530) shows the simplifying result of applying such an automated transformation.

Referring now to FIG, 6, an example is depicted for voice stress classification and speaker identification. A feature extraction window (610) provides a graphical user interface for this example of automated voice stress classification and speaker identification. Raw time series data is transformed using techniques known in the art such as, for example, linear predictive coding coefficients, Cepstral coefficients, delta-Cepstral coefficients, discrete wavelet transform coefficients, pitch tracking, energy transition, and harmonic features. Other processing can include known techniques such as constant false alarm rate detection (to remove silence), speech/non-speech separation, speaker separation, and adaptive thresholding. A feature names display (620) lists features identified in this example with such tools. It is within the scope of this invention to use such now known or later developed practices for automatic preprocessing within the context of the above described embodiments and modes for an improved data-mining application.

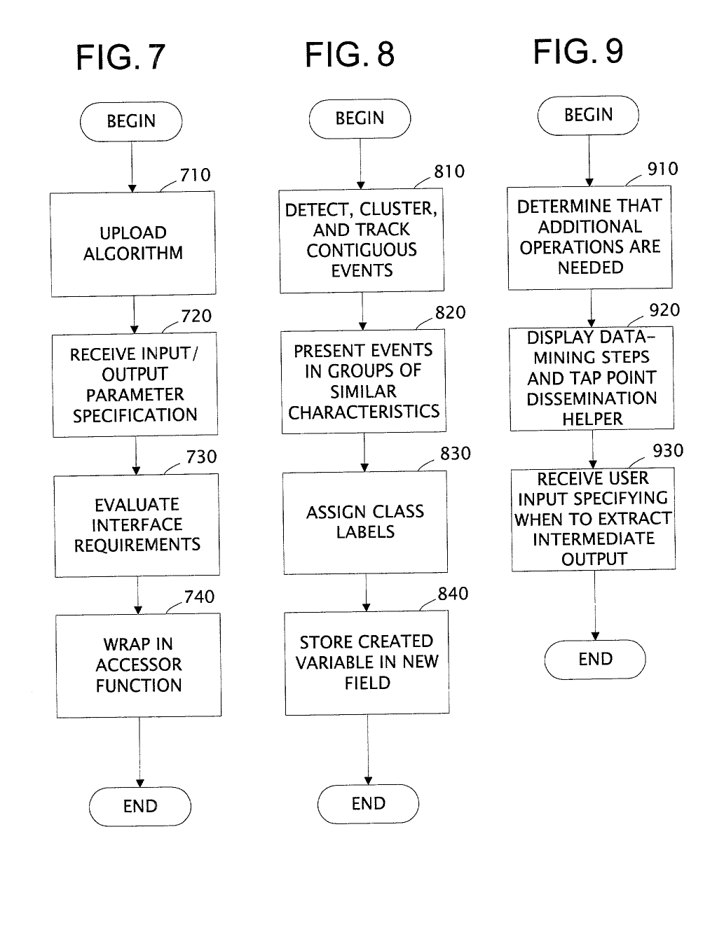

Referring now to FIG. 7, there is depicted a program flowchart for a sequence of operations and the passing of control in an embodiment of a tool for inserting a custom algorithm in a data-mining application. An upload-algorithm process (710) uploads a definition of the user algorithm. The algorithm can be defined by source code written in a high-level language such as, for example, C, C++, Java, Matlab, Fortran, Pascal, and Visual Basic. Other examples of ways to define an algorithm known to those of skill in the art are considered equivalent and within the scope of the claims below. Control passes to a receive-input/output-parameter-specification process (720). Examples of input and output parameters include data format, default values, help dialogs, and parameter relationships, as well as access permissions for the algorithm. Control passes to an-evaluate-interface-requirements process (730), which examines the algorithm to ensure that the user has properly implemented interface requirements such as, for example, an entry point and exit state. Control passes to a wrap-in-accessor-function process (740), wherein a back-end procedure can wrap the algorithm in an appropriate language-specific accessor function.

Referring now to FIG. 8, there is depicted a program flowchart for a sequence of operations and the passing of control in an embodiment of GUI-based ground truth tool for situations in which there is no obvious target variable. A detect-cluster—track-contiguous-events process (810) can use digital signal processing or image processing functions that detect, cluster, and/or track spatially and/or temporally related events, respectively. An embodiment can include one or more of any combination of such functions, and they can be built-in. Control passes to a present-events-in-groups-of-similar-characteristics process (820), in which these clustered and tracked events will be presented in groups of similar characteristics so that a data expert can easily and accurately assign the same class label (a value for a dependent variable) to them. Control passes to an assign-class-labels process (830), in which the data expert (which may be human or automatic) provides the class labels associated with each event. Control passes to a store-created-variable-in-new-field process (840), in which the class labels are added as a new column of data to the table for analysis in a data mining application.

Referring now to FIG. 9, there is depicted a program flowchart for a sequence of operations and the passing of control in an embodiment for providing file-based tap points for seamless insertion of user algorithms for customization of a data-mining application. In a determine-that-additional-operations-are-needed process (910), the user and the algorithm conclude that additional operations that must be performed on the data before it is submitted to the data mining application are too complex to be specified easily in a simple text-box environment. This decision typically can occur during data exploration guided by a decision tree or Bayesian network. Control passes to a display-data-mining-steps-and-tap-point-dissemination-helper process (920). Control passes to a receive-user-input-specifying-when-to-extract-intermediate-output process (930), in which the user can specify when and in what format to extract data for further processing.

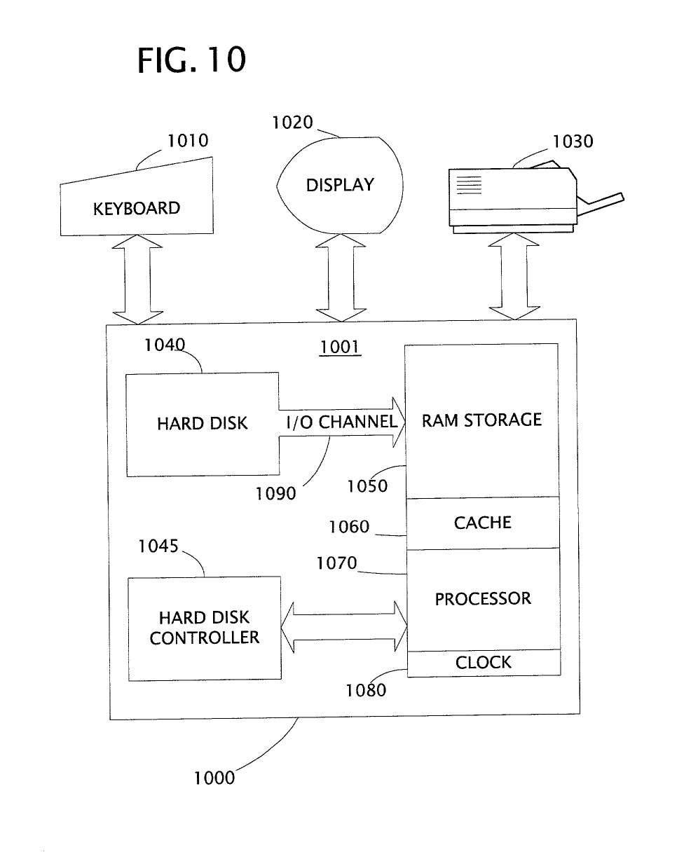

Referring now to FIG. 10, there is disclosed a block diagram that generally depicts an example of a configuration of hardware (1000) suitable for a GUI based ground truth tool and user-defined algorithms in data mining. A general-purpose digital computer (1001) includes a hard disk (1040), a hard disk controller (1045), ram storage (1050), an optional cache (1060), a processor (1070), a clock (1080), and various I/O channels (1090). In one embodiment, the hard disk (1040) will store data mining application software, raw data for data mining, and an algorithm knowledge database. Many different types of storage devices may be used and are considered equivalent to the hard disk (1040), including but not limited to a floppy disk, a CD-ROM, a DVD-ROM, an online web site, tape storage, and compact flash storage. In other embodiments not shown, some or all of these units may be stored, accessed, or used off-site, as, for example, by an internet connection. The I/O channels (1090) are communications channels whereby information is transmitted between RAM storage and the storage devices such as the hard disk (1040). The general-purpose digital computer (1001) may also include peripheral devices such as, for example, a keyboard (1010), a display (1020), or a printer (1030) for providing run-time interaction and/or receiving results. Other suitable platforms include networked hardware in a server/client configuration and a web-based application.

While the present invention has been described in the context of particular exemplary data structures, processes, and systems, those of ordinary skill in the art will appreciate that the processes of the present invention are capable of being distributed in the form of a computer readable medium of instructions and a variety of forms and that the present invention applies equally regardless of the particular type of signal bearing computer readable media actually used to carry out the distribution. Computer readable media includes any recording medium in which computer code may be fixed, including but not limited to CD's, DVD's, semiconductor ram, rom, or flash memory, paper tape, punch cards, and any optical, magnetic, or semiconductor recording medium or the like. Examples of computer readable media include recordable-type media such as floppy disc, a hard disk drive, a RAM, and CD-ROMs, DVD-ROMs, an online internet web site, tape storage, and compact flash storage, and transmission-type media such as digital and analog communications links, and any other volatile or non-volatile mass storage system readable by the computer. The computer readable medium includes cooperating or interconnected computer readable media, which exist exclusively on single computer system or are distributed among multiple interconnected computer systems that may be local or remote. Those skilled in the art will also recognize many other configurations of these and similar components which can also comprise computer system, which are considered equivalent and are intended to be encompassed within the scope of the claims herein.

Although embodiments have been shown and described, it is to be understood that various modifications and substitutions, as well as rearrangements of parts and components, can be made by those skilled in the art, without departing from the normal spirit and scope of this invention. Having thus described the invention in detail by way of reference to preferred embodiments thereof, it will be apparent that other modifications and variations are possible without departing from the scope of the invention defined in the appended claims. Therefore, the spirit and scope of the appended claims should not be limited to the description of the preferred versions contained herein. The appended claims are contemplated to cover the present invention any and all modifications, variations, or equivalents that fall within the true spirit and scope of the basic underlying principles disclosed and claimed herein.

### Industrial Applicability

The modes and embodiments disclosed hereinabove can facilitates sophisticated data mining when no target variables are readily available. They can be used as part of a data mining tool available for sales or licensing.

1. A user interface for inserting a custom algorithm in a data-mining application, the user interface comprising:
a control to upload algorithm code;
a control to query the user for input and output parameter information;
wherein the user interface is available to pass the algorithm source code to an evaluation process, the evaluation process being available to determine whether the user has properly implemented interface requirements; and
wherein the user interface is available to pass the algorithm source code to a wrapping process that wraps the algorithm in an appropriate language-specific accessor function.

2. The user interface according to claim 1 wherein the algorithm source code is written in a high level-language.

3. The user interface according to claim 2 wherein the high-level language is selected from the group consisting of C, C++, Java, Matlab, Fortran, Pascal, and Visual Basic.

4. The user interface according to claim 1 wherein the control to upload an algorithm source code is a single control element.

5. The user interface according to claim 1 wherein the control to upload an algorithm source code is a plurality of elements comprising a text box in which to identify a file, a browse button with which to select a file, and an upload button with which to initiate the upload process.

6. The user interface according to claim 1 wherein the input and output parameter information comprises data format, default values, help dialogs, and parameter relationships.

7. The user interface according to claim 1 wherein the interface requirements checked by the evaluation process include an entry point into the code and exit state.

8. The user interface according to claim 1 wherein the wrapping process is a back-end procedure.

9. A method for inserting a custom algorithm in a data-mining application, the method comprising:
uploading an algorithm source code;
receiving input and output parameter information from the user;
evaluating the algorithm source code to determine whether the user has properly implemented interface requirements; and
passing the algorithm source code to a wrapping process that wraps the algorithm in an appropriate language-specific accessor function.

10. The method for inserting a custom algorithm in a data-mining application according to claim 9 wherein the algorithm source code is written in a high level-language.

11. The method for inserting a custom algorithm in a data-mining application according to claim 10 wherein the high-level language is selected from the group consisting of C, C++, Java, Matlab, Fortran, Pascal, and Visual Basic.

12. The method for inserting a custom algorithm in a data-mining application according to claim 9 wherein the processes are tied to a user interface.

13. The method for inserting a custom algorithm in a data-mining application according to claim 9 wherein processes are performed by a separate application.

14. The method for inserting a custom algorithm in a data-mining application according to claim 9 wherein the input and output parameter information comprises data format, default values, help dialogs, and parameter relationships.

15. The method for inserting a custom algorithm in a data-mining application according to claim 9 wherein the interface requirements evaluated include an entry point into the code and exit state.

16. The method for inserting a custom algorithm in a data-mining application according to claim 9 wherein the wrapping process is a back-end procedure.

17. An interface for inserting a customer algorithm into a data-mining application, the interface comprising:
a means for uploading an algorithm source code;
a means for receiving input and output parameter information from the user;
a means for evaluating the algorithm source code to determine whether the user has properly implemented interface requirements; and
a means for passing the algorithm source code to a wrapping process that wraps the algorithm in an appropriate language-specific accessor function.

18. The interface for inserting a custom algorithm in a data-mining application according to claim 17 wherein the algorithm source code is written in a high level-language.

19. The interface for inserting a custom algorithm in a data-mining application according to claim 18 wherein the high-level language is selected from the group consisting of C, C++, Java, Matlab, Fortran, Pascal, and Visual Basic.

20. The interface for inserting a custom algorithm in a data-mining application according to claim 17 wherein the means are contained in a user interface.

21. The interface for inserting a custom algorithm in a data-mining application according to claim 17 wherein means are contained in a separate application.

22. The interface for inserting a custom algorithm in a data-mining application according to claim 17 wherein the input and output parameter information comprises data format, default values, help dialogs, and parameter relationships.

23. The interface for inserting a custom algorithm in a data-mining application according to claim 17 wherein the interface requirements evaluated include an entry point into the code and exit state.

24. The interface for inserting a custom algorithm in a data-mining application according to claim 17 wherein the wrapping process is a back-end procedure.

25. An article of manufacture for inserting a customer algorithm into an analysis environment, comprising a computer readable media containing:
a computer program code segment that uploads an algorithm source code;
a computer program code segment that receives input and output parameter information from the user;
a computer program code segment that evaluates the algorithm source code to determine whether the user has properly implemented interface requirements; and
a computer program code segment that passes the algorithm source code to a wrapping process that wraps the algorithm in an appropriate language-specific accessor function.

26. The article of manufacture for inserting a custom algorithm in a data-mining application according to claim 25 wherein the algorithm source code is written in a high level-language.

27. The article of manufacture for inserting a custom algorithm in a data-mining application according to claim 26 wherein the high-level language is selected from the group consisting of C, C++, Java, Matlab, Fortran, Pascal, and Visual Basic.

28. The article of manufacture for inserting a custom algorithm in a data-mining application according to claim 25 wherein the computer readable medium further comprises a user interface comprising the computer program code segments.

29. The article of manufacture for inserting a custom algorithm in a data-mining application according to claim 25 wherein computer program code segments are part of a separate application.

30. The article of manufacture for inserting a custom algorithm in a data-mining application according to claim 25 wherein the input and output parameter information comprises data format, default values, help dialogs, and parameter relationships.

31. The article of manufacture for inserting a custom algorithm in a data-mining application according to claim 25 wherein the interface requirements evaluated include an entry point into the code and exit state.

32. The article of manufacture for inserting a custom algorithm in a data-mining application according to claim 25 wherein the wrapping process is a back-end procedure.

33. A data-mining computer system adapted for inserting a custom algorithm into the data mining application, comprising:
an upload control that uploads an algorithm source code;
a parameter control that receives input and output parameter information from the user;
an evaluation process that evaluates the algorithm source code to determine whether the user has properly implemented interface requirements; and
a wrapping process that wraps the algorithm in an appropriate language-specific accessor function.

34. The data-mining computer system according to claim 33 wherein the algorithm source code is written in a high level-language.

35. The data-mining computer system according to claim 34 wherein the high-level language is selected from the group consisting of C, C++, Java, Matlab, Fortran, Pascal, and Visual Basic.

36. The data-mining computer system according to claim 33 further comprising a user interface comprising the upload control and the parameter control.

37. The data-mining computer system according to claim 33 wherein the upload control and the parameter control are inputs for an application.

38. The data-mining computer system according to claim 33 wherein the input and output parameter information comprises data format, default values, help dialogs, and parameter relationships.

39. The data-mining computer system according to claim 33 wherein the evaluation process evaluates an entry point into the code and exit state.

40. The data-mining computer system according to claim 33 wherein the wrapping process is a back-end procedure.

41. A client system adapted for inserting a custom algorithm into a data-mining application, the client system comprising:
an upload control that uploads an algorithm source code;
a parameter control that receives input and output parameter information from the user;
an evaluation process link that can call an evaluation process available to evaluate the algorithm source code to determine whether the user has properly implemented interface requirements; and
a wrapping process link that can call a wrapping process available to wrap the algorithm in an appropriate language-specific accessor function.

42. The client system according to claim 41 wherein the algorithm source code is written in a high level-language.

43. The client system according to claim 42 wherein the high-level language is selected from the group consisting of C, C++, Java, Matlab, Fortran, Pascal, and Visual Basic.

44. The client system according to claim 41 further comprising a user interface comprising the upload control and the parameter control.

45. The client system according to claim 41 wherein the upload control and the parameter control each present a prompt to the user and receive user input.

46. The client system according to claim 41 wherein the input and output parameter information comprises data format, default values, help dialogs, and parameter relationships.

47. The client system according to claim 41 wherein the evaluation process evaluates an entry point into the code and exit state.

48. The client system according to claim 41 wherein the wrapping process is a back-end procedure.

49. A server system wherein a custom algorithm can be inserted into an analysis environment, the server system comprising:
an upload control that uploads an algorithm source code;
a parameter control that receives input and output parameter information from the user;
an evaluation process link that can call an evaluation process available to evaluate the algorithm source code to determine whether the user has properly implemented interface requirements; and
a wrapping process link that can call a wrapping process available to wrap the algorithm in an appropriate language-specific accessor function.

50. The server system according to claim 49 wherein the algorithm source code is written in a high level-language.

51. The server system according to claim 50 wherein the high-level language is selected from the group consisting of C, C++, Java, Matlab, Fortran, Pascal, and Visual Basic.

52. The server system according to claim 49 further comprising a user interface comprising the upload control and the parameter control.

53. The server system according to claim 49 wherein the upload control and the parameter control each present a prompt to the user and receive user input.

54. The server system according to claim 49 wherein the input and output parameter information comprises data format, default values, help dialogs, and parameter relationships.

55. The server system according to claim 49 wherein the evaluation process evaluates an entry point into the code and exit state.

56. The server system according to claim 49 wherein the wrapping process is a back-end procedure.

57. A computer data signal embodied in a carrier wave encoding a computer program for inserting a custom algorithm in a data-mining application, the computer program comprising instructions for performing the method of claim 9.

58. The computer data signal embodied in a carrier wave encoding a computer program for inserting a custom algorithm in a data-mining application according to claim 57, wherein the algorithm source code is written in a high level-language.

59. The computer data signal embodied in a carrier wave encoding a computer program for inserting a custom algorithm in a data-mining application according to claim 58, wherein the high-level language is selected from the group consisting of C, C++, Java, Matlab, Fortran, Pascal, and Visual Basic.

60. The computer data signal embodied in a carrier wave encoding a computer program for inserting a custom algorithm in a data-mining application according to claim 57, wherein the processes are tied to a user interface.

61. The computer data signal embodied in a carrier wave encoding a computer program for inserting a custom algorithm in a data-mining application according to claim 57, wherein processes are performed by a separate application.

62. The computer data signal embodied in a carrier wave encoding a computer program for inserting a custom algorithm in a data-mining application according to claim 57, wherein the input and output parameter information comprises data format, default values, help dialogs, and parameter relationships.

63. The computer data signal embodied in a carrier wave encoding a computer program for inserting a custom algorithm in a data-mining application according to claim 57, wherein the interface requirements evaluated include an entry point into the code and exit state.

64. The computer data signal embodied in a carrier wave encoding a computer program for inserting a custom algorithm in a data-mining application according to claim 57, wherein the wrapping process is a back-end procedure.

65. A method of providing a ground truth tool in a database having data fields, comprising:
processing to detect, to cluster, and to track contiguous events;
presenting detected, clustered, and tracked contiguous events in groups wherein the members of each group have similar characteristics; and
receiving input assigning class labels to the events.

66. The method of providing a ground truth tool according to claim 65 wherein the processing is digital signal processing to detect, to cluster, and to track temporally contiguous events.

67. The method of providing a ground truth tool according to claim 65 wherein the processing is image processing to detect, to cluster, and to track spatially contiguous events.

68. The method of providing a ground truth tool according to claim 65 further comprising storing the class labels in a new data field appended the database.

69. The method of providing a ground truth tool according to claim 65 wherein events are presented and input is received on controls of a user interface.

70. A computer program storage medium readable by a computing system and encoding a computer program for providing a ground truth tool, the computer program comprising instructions for performing the method of claim 65.

71. A computer program storage medium readable by a computing system and encoding a computer program for providing a ground truth tool, the computer program comprising instructions for performing the method of claim 66.

72. A computer program storage medium readable by a computing system and encoding a computer program for providing a ground truth tool, the computer program comprising instructions for performing the method of claim 67.

73. A computer program storage medium readable by a computing system and encoding a computer program for providing a ground truth tool, the computer program comprising instructions for performing the method of claim 68.

74. A computer program storage medium readable by a computing system and encoding a computer program for providing a ground truth tool, the computer program comprising instructions for performing the method of claim 69.

75. A computer data signal embodied in a carrier wave by a computing system and encoding a computer program for providing a ground truth tool, the computer program comprising instructions to perform the method of claim 65.

76. A computer data signal embodied in a carrier wave by a computing system and encoding a computer program for providing a ground truth tool, the computer program comprising instructions for performing the method of claim 66.

77. A computer data signal embodied in a carrier wave by a computing system and encoding a computer program for providing a ground truth tool, the computer program comprising instructions for performing the method of claim 67.

78. A computer data signal embodied in a carrier wave by a computing system and encoding a computer program for providing a ground truth tool, the computer program comprising instructions for performing the method of claim 68.

79. A computer data signal embodied in a carrier wave by a computing system and encoding a computer program for providing a ground truth tool, the computer program comprising instructions for performing the method of claim 69.

80. A computer system having a data-mining application and including a ground truth tool, the system comprising:
means for detecting, clustering, and tracking contiguous events;
means for presenting detected, clustered, and tracked contiguous events in groups wherein the members of each group have similar characteristics;
means for receiving input assigning class labels to the events.

81. The computer system according to claim 80 wherein the means for detecting, clustering, and tracking contiguous events is a digital signal processor to detect, to cluster, and to track temporally contiguous events.

82. The computer system according to claim 80 wherein the means for detecting, clustering, and tracking contiguous events is an image processor to detect, to cluster, and to track spatially contiguous events.

83. The computer system according to claim 80 further comprising a means for storing the class labels in a new data field appended the database.

84. The computer system according to claim 80 wherein events are presented and input is received on controls of a user interface.

85. A method for seamless insertion of custom algorithms in a data-mining application using tap points, the method comprising:
using a computer system for machine-assisted problem exploration in a data-mining application, the computer system having a problem-definition user interface;
concluding that additional operations are needed that are too complicated to be specified easily using the problem-definition interface;
displaying to the user all data-mining steps and a tap-point dissemination helper; and
receiving input from the user specifying when to extract an intermediate output for further processing.

86. The method according to claim 85 wherein the tap points are file-based.

87. The method according to claim 85 wherein the tap points are not file-based.

88. The method according to claim 85 wherein the machines-assisted problem definition uses a Bayesian network.

89. The method according to claim 85 wherein the machines-assisted problem definition uses a decision tree.

90. The method according to claim 85 wherein the displaying step and the receiving input step use a user interface.

91. The method according to claim 85 wherein user input specifies the format in which data will output.

92. A user interface adapted for specifying data tap-points in a data-mining application, the interface comprising:
an output that displays information about the data-mining steps and a tap-point dissemination helper; and
an input that receives information from the user to specify when to extract an intermediate output for further processing.

93. The user interface according to claim 92 wherein the output is a control on a user interface and the input is a control on a user interface.

94. The user interface according to claim 92 wherein intermediate output is extracted at file-based tap points identified by the user.

95. A computer readable medium comprising instructions for seamless insertion of custom algorithms in a data-mining application using tap points, said instructions comprising the acts of:
using a computer system for machine-assisted problem exploration in a data-mining application, the computer system having a problem-definition user interface;
concluding that additional operations are needed that are too complicated to be specified easily using the problem-definition interface;
displaying to the user all data-mining steps and a tap-point dissemination helper; and
receiving input from the user specifying when to extract an intermediate output for further processing.

96. The computer readable medium according to claim 95 wherein the tap points are file-based.

97. The computer readable medium according to claim 95 wherein the tap points are not file-based.

98. The computer readable medium according to claim 95 wherein the machines-assisted problem definition uses a Bayesian network.

99. The computer readable medium according to claim 95 wherein the machines-assisted problem definition uses a decision tree.

100. The computer readable medium according to claim 95 wherein the displaying step and the receiving input step use a user interface.

101. The computer readable medium according to claim 95 wherein user input specifies the format in which data will output.

102. A computer data signal embodied in a carrier wave and representing sequences of instructions which, when executed by a processor, cause said processor to seamlessly insert a custom algorithms in a data-mining application using tap points by performing the steps of:
using a computer system for machine-assisted problem exploration in a data-mining application, the computer system having a problem-definition user interface;
concluding that additional operations are needed that are too complicated to be specified easily using the problem-definition interface;
displaying to the user all data-mining steps and a tap-point dissemination helper; and
receiving input from the user specifying when to extract an intermediate output for further processing.

103. The computer data signal according to claim 102 wherein the tap points are file-based.

104. The computer data signal according to claim 102 wherein the tap points are not file-based.

105. The computer data signal according to claim 102 wherein the machines-assisted problem definition uses a Bayesian network.

106. The computer data signal according to claim 102 wherein the machines-assisted problem definition uses a decision tree.

107. The computer data signal according to claim 102 wherein the displaying step and the receiving input step use a user interface.

108. The computer data signal according to claim 102 wherein user input specifies the format in which data will output.

109. A computer system including means for seamless insertion of custom algorithms in a data-mining application using tap points, the computer system comprising:
means for using a computer system for machine-assisted problem exploration in a data-mining application, the computer system having a problem-definition user interface;
means for concluding that additional operations are needed that are too complicated to be specified easily using the problem-definition interface;
means for displaying to the user all data-mining steps and a tap-point dissemination helper; and
means for receiving input from the user specifying when to extract an intermediate output for further processing.

110. The computer system according to claim 109 wherein the tap points are file-based.

111. The computer system according to claim 109 wherein the tap points are not file-based.

112. The computer system according to claim 109 wherein the machines-assisted problem definition uses a Bayesian network.

113. The computer system according to claim 109 wherein the machines-assisted problem definition uses a decision tree.

114. The computer system according to claim 109 wherein the displaying means and the receiving input means comprise a user interface.

115. The computer system according to claim 109 wherein user input specifies the format in which data will output.

116. A computer system including seamless insertion of custom algorithms in a data-mining application using tap points, the computer system comprising:
a memory and a central processor;
a machine-assisted problem exploration processor in a data-mining application;
an output device, the output device communicating data-mining steps and a tap-point dissemination helper; when additional operations are needed that are too complicated to be specified easily using the machine-assisted problem exploration processor; and
an input device for receiving input from the user specifying when to extract an intermediate output for further processing.

117. The computer system according to claim 116 wherein the output device is a member of the group consisting of a cathode ray tube and a printer.

118. The computer system according to claim 116 wherein the input device is a keyboard.
